(19) United States
(12) Patent Application Publication
(10) Pub. No.: US 2011/0285641 A1
(43) Pub. Date: Nov. 24, 2011

(54) TOUCH-SENSING DISPLAY PANEL AND TOUCH-SENSING COLOR FILTER SUBSTRATE

(75) Inventor: Cheng-Chung Huang, Taoyuan County (TW)

(73) Assignee: UNIDISPLAY INC., Hsinchu County (TW)

(21) Appl. No.: 12/826,707

(22) Filed: Jun. 30, 2010

(30) Foreign Application Priority Data
May 20, 2010 (TW) 99116102

(51) Int. Cl. G06F 3/041

(52) U.S. Cl. 345/173

(57) ABSTRACT

A touch-sensing display panel and a touch-sensing color filter substrate are provided. The touch-sensing display panel includes an array substrate, the touch-sensing color filter substrate, and a display medium. The touch-sensing color filter substrate is disposed above the array substrate. The display medium is arranged between the array substrate and the touch-sensing color filter substrate. The touch-sensing color filter substrate includes a substrate, a plurality of color filter films, a first electrode layer, and a second electrode layer. The substrate has an outer surface and an inner surface opposite to the outer surface. The color filter films are disposed on the inner surface. The first electrode layer is disposed between the substrate and the color filter films. The second electrode layer is disposed on the outer surface.

### CROSS-REFERENCE TO RELATED APPLICATION

This application claims the priority benefit of Taiwan application serial no. 99116102, filed on May 20, 2010. The entirety of the above-mentioned patent application is hereby incorporated by reference herein and made a part of this specification.

### BACKGROUND OF THE INVENTION

1. Field of the Invention

The invention relates to a touch-sensing display panel and a touch-sensing color filter substrate. More particularly, the invention relates to a capacitive touch-sensing display panel and a touch-sensing color filter substrate.

2. Description of Related Art

Increasing progress of the display technology brings great conveniences to people's daily lives. Due to the requirements for lightness and compactness, flat panel displays (FPD) complying with said requirements have become the mainstream products at present. Recently, various electronic products have been developed toward easy operation as well as compactness and equipped with large-sized display screens, and portable electronic products even have a relatively high standard regarding compact volume and large-sized screens. As a result, a touch-sensing design is frequently applied to display panels on the electronic devices, such that more space can be provided due to omission of keyboards or controlling keypads, and that the demands for increasing screen size can be satisfied.

In general, a touch-sensing display panel includes a display panel and a touch-sensing panel which is able to be built in or attached to the display panel. Based on different sensing types, the touch-sensing panel can be mainly categorized into a resistive touch-sensing panel, a capacitive touch-sensing panel, an optical touch-sensing panel, an acoustic-wave touch-sensing panel, and an electromagnetic touch-sensing panel. The capacitive touch-sensing panel is characterized by short response time, favorable reliability, satisfactory durability, and so on. Therefore, the capacitive touch sensing panel has been extensively applied to the electronic products. According to structural and manufacturing differences, the capacitive touch-sensing panel can be further classified into an added-on touch-sensing panel, an on-cell touch-sensing panel, and an in-cell touch-sensing panel. In the added-on capacitive touch-sensing panel, touch-sensing series are formed on an auxiliary substrate, and the auxiliary substrate having the touch-sensing series is then adhered to an outer surface of a display. Apparently, the auxiliary substrate brings about an increase in overall thickness of the added-on touch-sensing panel. In comparison with the added-on touch-sensing panel, the on-cell touch-sensing panel and the in-cell touch-sensing panel can easily achieve miniaturization and compactness of the display. Nonetheless, no matter the added-type touch-sensing panel, the on-cell touch-sensing panel, or the in-cell touch-sensing panel is employed, touch-sensing circuits featuring sensing capabilities are all formed on the same surface of a substrate. In order to perform capacitive touch-sensing functions, additional manufacturing processes are needed to electrically insulate the touch-sensing circuits from one another.

### SUMMARY OF THE INVENTION

The invention is directed to a touch-sensing display in which a first electrode layer and color filter films are disposed on an inner surface of a substrate, and a second electrode layer is disposed on an outer surface of the substrate.

The invention is further directed to a touch-sensing color filter substrate integrating touch-sensing electrodes and color filter films.

In the invention, a touch-sensing display panel including an array substrate, a touch-sensing color filter substrate, and a display medium is provided. The touch-sensing color filter substrate is disposed above the array substrate. The display medium is arranged between the array substrate and the touch-sensing color filter substrate. The touch-sensing color filter substrate includes a substrate, a plurality of color filter films, a first electrode layer, and a second electrode layer. The substrate has an outer surface and an inner surface opposite to the outer surface. The color filter films are disposed on the inner surface of the substrate. The first electrode layer is disposed between the substrate and the color filter films. The second electrode layer is disposed on the outer surface of the substrate.

In the invention, a touch-sensing color filter substrate including a substrate, a plurality of color filter films, a first electrode layer, and a second electrode layer is further provided. The substrate has an outer surface and an inner surface opposite to the outer surface. The color filter films are disposed on the inner surface of the substrate. The first electrode layer is disposed between the substrate and the color filter films. The second electrode layer is disposed on the outer surface of the substrate.

According to an embodiment of the invention, the first electrode layer includes a plurality of first touch-sensing series extending along a first direction and arranged in parallel. According to an embodiment of the invention, the second electrode layer includes a plurality of second touch-sensing series extending along a second direction and arranged in parallel. The first direction is not parallel to the second direction, and the first touch-sensing series are electrically insulated from the second touch-sensing series.

According to an embodiment of the invention, the touch-sensing color filter substrate further includes an insulation layer disposed between the first electrode layer and the color filter films.

According to an embodiment of the invention, the touch-sensing color filter substrate further includes a light-shielding pattern that defines a plurality of sub-pixel regions on the substrate, and each of the color filter films is arranged corresponding to one of the sub-pixel regions.

According to an embodiment of the invention, the touch-sensing color filter substrate further includes a planarization layer that covers the color filter films.

According to an embodiment of the invention, the array substrate includes an active device array structure, the touch-sensing color filter substrate further includes a common electrode, and the display medium is disposed between the active device array structure and the common electrode.

According to an embodiment of the invention, the array substrate includes a plurality of first stripe electrodes arranged in parallel, the touch-sensing color filter substrate further includes a plurality of second stripe electrodes arranged in parallel, an extension direction of the first stripe electrodes intersects an extension direction of the second stripe electrodes, and the display medium is disposed between the first stripe electrodes and the second stripe electrodes.

According to an embodiment of the invention, the touch-sensing display panel further includes a polarizer. The polarizer, for instance, is disposed below the array substrate, such that the array substrate is located between the polarizer and the display medium. Alternatively, the polarizer, for instance, is disposed above the touch-sensing color filter substrate, such that the touch-sensing color filter substrate is disposed between the polarizer and the display medium.

According to an embodiment of the invention, the touch-sensing display panel further includes a first polarizer and a second polarizer, the array substrate is located between the first polarizer and the display medium, and the touch-sensing color filter substrate is located between the second polarizer and the display medium.

According to an embodiment of the invention, a material of the first electrode layer and the second electrode layer includes a transparent conductive material.

According to an embodiment of the invention, the display medium includes a liquid crystal material, a discharge gas for generating plasma, an organic luminescent material, or an electrowetting material.

According to an embodiment of the invention, the touch-sensing color filter substrate further includes a planarization layer and a common electrode. The planarization layer covers the color filter films. The common electrode is disposed on the planarization layer.

According to an embodiment of the invention, the touch-sensing color filter substrate further includes a planarization layer and a plurality of stripe electrodes. The planarization layer covers the color filter films. The stripe electrodes are disposed on the planarization layer.

Based on the above, in the touch-sensing display panel and the touch-sensing color filter substrate of the invention, the first electrode layer and the second electrode layer are respectively formed on the inner surface and the outer surface of the substrate, and the color filter films are integrated on the inner surface of the substrate. Hence, the touch-sensing display panel and the touch-sensing color filter substrate of the invention can perform both the touch-sensing function and the filter function. On the other hand, since the color filter films, the first electrode layer, and the second electrode layers are integrated in the same substrate, and therefore the manufacturing process can be simplified, the manufacturing costs can be reduced, and the touch-sensing display panel and the touch-sensing color filter substrate of the invention are applicable to the display products featuring compactness.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic top view illustrating a touch-sensing display panel according to an embodiment of the invention.

FIG. 2 is a schematic cross-sectional view taken along a line segment I-I′ depicted in FIG. 1.

### DESCRIPTION OF EMBODIMENTS

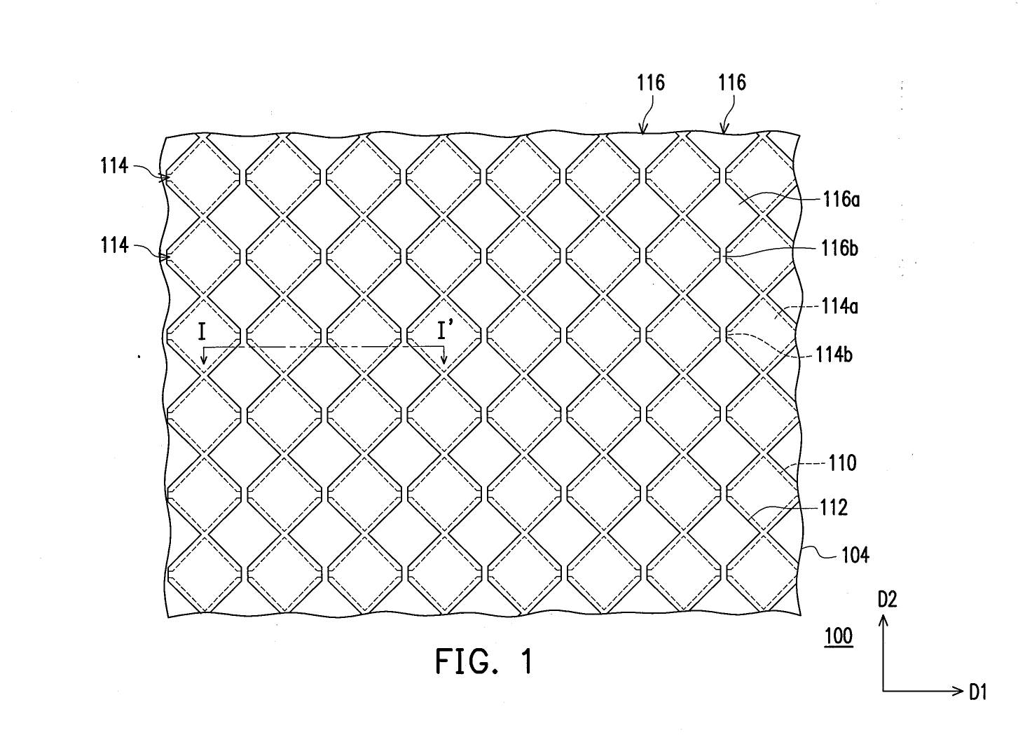

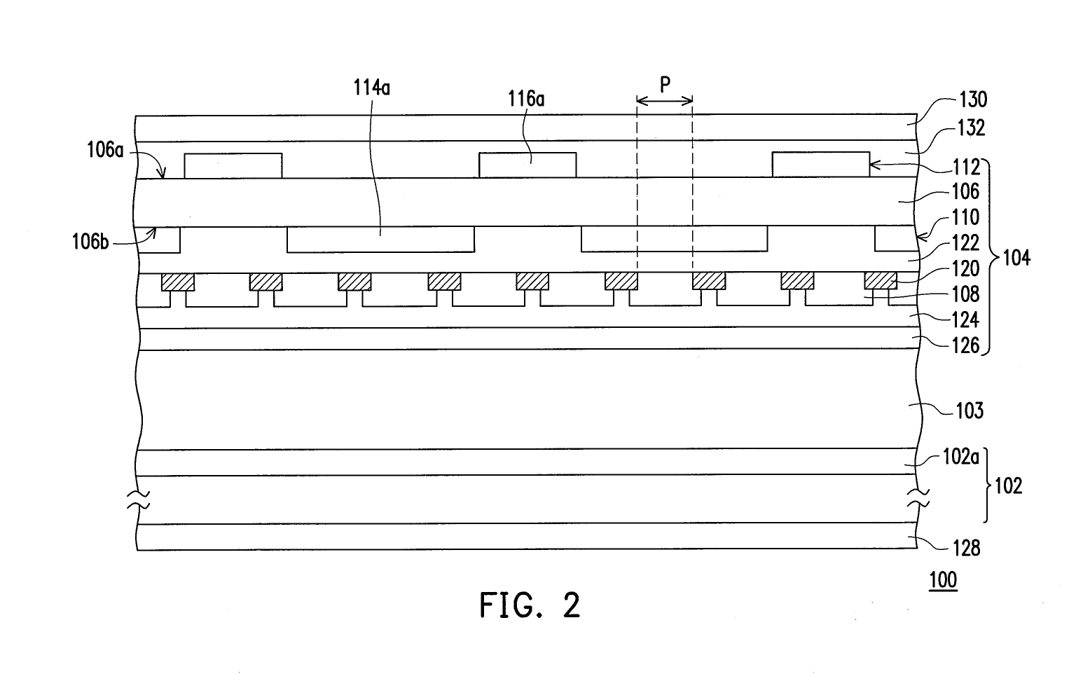

FIG. 1 is a schematic top view illustrating a touch-sensing display panel according to an embodiment of the invention. FIG. 2 is a schematic cross-sectional view taken along a line segment I-I′ depicted in FIG. 1. In this embodiment, the arrangement of the first electrode layer and the second electrode layer is depicted in FIG. 1 to better elucidate the invention, which however does not pose limitations on the scope of the invention.

As shown in FIG. 1 and FIG. 2, a touch-sensing display panel 100 includes an array substrate 102, a display medium 103, and a touch-sensing color filter substrate 104. The touch-sensing color filter substrate 104 is disposed above the array substrate 102. The display medium 103 is arranged between the array substrate 102 and the touch-sensing color filter substrate 104. The array substrate 102 includes a device structure layer 102a. The display medium 103 includes a liquid crystal material, a discharge gas for generating plasma, an organic luminescent material, or an electrowetting material. In other words, based on different display media, the touch-sensing display panel 100 can be classified into a liquid crystal display (LCD) panel, a plasma display panel, an organic luminescent display panel, or an electrowetting display panel.

Specifically, the touch-sensing color filter substrate 104 includes a substrate 106, a plurality of color filter films 108, a first electrode layer 110, and a second electrode layer 112. The substrate 106 has an outer surface 106a and an inner surface 106b opposite to the outer surface 106a. The color filter films 108 and the first electrode layer 110 are disposed on the inner surface 106b of the substrate 106. The first electrode layer 110 is disposed between the substrate 106 and the color filter films 108. The second electrode layer 112 is disposed on the outer surface 106a of the substrate 106. The substrate 106, for example, is a transparent substrate which is a rigid substrate (e.g. a glass substrate) or a flexible substrate (e.g. a plastic substrate).

The first electrode layer 110 at least includes a plurality of first touch-sensing series 114, and the first touch-sensing series 114 extend along a first direction D1 and are arranged in parallel. Each of the first touch-sensing series 114 includes a plurality of first sensing pads 114a and a plurality of first connection lines 114b, and the first connection lines 114b are arranged along the first direction D1 and serially connected to the first sensing pads 114a.

The second electrode layer 112 at least includes a plurality of second touch-sensing series 116 extending along a second direction D2 and arranged in parallel. The first direction Dl is not parallel to the second direction D2. According to this embodiment, the first direction D1 is substantially perpendicular to the second direction D2. Each of the second touch-sensing series 116 includes a plurality of second sensing pads 116a and a plurality of second connection lines 116b, and the second connection lines 116b are arranged along the second direction D2 and serially connected to the second sensing pads 116a.

In order to perform the capacitive touch-sensing function, each of the first sensing pads 114a is separated from each of the second sensing pads 116a, and the first touch-sensing series 114 are electrically insulated from the second touch-sensing series 116. In this embodiment, the first sensing pads 114a and the first connection lines 114b are coplanar and located on the inner surface 106b of the substrate 106, and the second sensing pads 116a and the second connection lines 116b are coplanar and located on the outer surface 106a of the substrate 106, such that the first touch-sensing series 114 can be electrically insulated from the second touch-sensing series 116. When a user touches the touch-sensing display panel 100, coupling capacitance at an overlapping area between the first touch-sensing series 114 and the second touch-sensing series 116 is varied because of the touch action of the user, and thereby signals are generated to control an electronic device.

A material of the first electrode layer 110 and the second electrode layer 112 includes a transparent conductive material. A material of the first touch-sensing series 114 and the second touch-sensing series 116, for instance, is indium tin oxide (ITO), indium zinc oxide (IZO), aluminum zinc oxide (AZO), Ga doped zinc oxide (GZO), indium oxide (In₂O₃), zinc oxide (ZnO), titanium dioxide (TiO₂), or tin dioxide (SnO₂). The first electrode layer 110 and the second electrode layer 112 are not necessarily formed by the first touch-sensing series 114 and the second touch-sensing series 116, and each of the touch-sensing series does not necessarily have the structure depicted in FIG. 1.

The touch-sensing color filter substrate 104 further includes a light-shielding pattern 120. The light-shielding pattern 120 define a plurality of sub-pixel regions P on the substrate 106, and each of the color filter films 108 is arranged corresponding to one of the sub-pixel regions P. To be more specific, the color filter films 108 can be a combination of red, green, and blue filter films, and the light-shielding pattern 120, for example, are black matrices or are formed by stacking red, green, and blue filter films. As long as a full-color display effect can be achieved, the color filter films 108 can have other color combinations in other embodiments, which is not limited in this invention.

In addition, according to an embodiment of the invention, the touch-sensing color filter substrate 104 can selectively include an insulation layer 122, a planarization layer 124, and an electrode layer 126 disposed on the planarization layer 124. The insulation layer 122, for example, is disposed between the first electrode layer 110 and the color filter films 108, which is conducive to maintaining favorable electrical properties of the first electrode layer 110. A material of the insulation layer 122, for example, is a dielectric material, such as polyimide (PI), silicon oxide (SiO), silicon nitride (SiN), silicon oxynitride (SiON), resin, or the like. The planarization layer 124 covers the color filter films 108. That is to say, the planarization layer 124, for example, is disposed between the color filter films 108 and the electrode layer 126. Space between the color filter films 108 and the light-shielding pattern 120 can be filled with the planarization layer 124, such that the color filter films 108 can be planarized to a better extent, which is conducive to subsequent formation of film layers. In addition, the electrode layer 126, for example, is disposed between the planarization layer 124 and the display medium 103, and thus the display medium 103 is controlled by electric field between the electrode layer 126 and the device structure layer 102a, and the display function is then achieved.

Particularly, the touch-sensing display panel 100 can be categorized into an active touch-sensing display panel and a passive touch-sensing display panel based on the manner in which the touch-sensing display panel 100 is driven. When the touch-sensing display panel 100 is the active touch-sensing display panel, the array substrate 102 is an active device array substrate, the device structure layer 102a, for example, is an active device array structure, and the electrode layer 126 on the opposite touch-sensing color filter substrate 104, for example, is a common electrode. The active device array structure can include active devices arranged in an array, pixel electrodes, scan lines, and data lines. The active device, for instance, is a thin film transistor. Here, the display medium 103 between each of the pixel electrodes and the common electrode can be individually driven.

By contrast, when the touch-sensing display panel 100 is the passive touch-sensing display panel, the device structure layer 102a on the array substrate 102 includes a plurality of first stripe electrodes arranged in parallel, and the electrode layer 126 on the opposite touch-sensing color filter substrate 104 includes a plurality of second stripe electrodes arranged in parallel. An extension direction of the first stripe electrodes intersects an extension direction of the second stripe electrodes, for instance. In an embodiment, the extension direction of the first stripe electrodes is substantially perpendicular to the extension direction of the second stripe electrodes. Here, the display medium 103 between each of the first stripe electrodes and each of the second stripe electrodes can be individually driven.

According to an embodiment of the invention, the touch-sensing display panel 100 further includes polarizers 128 and 130 located at two respective outer sides of the touch-sensing display panel 100. Specifically, the polarizer 128 is disposed below the array substrate 102, such that the array substrate 102 is located between the polarizer 128 and the display medium 103. Here, the polarizer 128 polarizes light entering the touch-sensing display panel 100. The polarizer 130 is disposed above the touch-sensing color filter substrate 104, such that the touch-sensing color filter substrate 104 is located between the polarizer 130 and the display medium 103. Here, the polarizer 130 polarizes light emitted from the touch-sensing display panel 100. Besides, an insulation layer 132 is further disposed between the polarizer 130 and the second electrode layer 112 of the touch-sensing color filter substrate 104. Space between the polarizer 130 and the second electrode layer 112 can be filled with the insulation layer 132 to achieve planarization to a better extent, and favorable electrical properties of the second electrode layer 112 can be guaranteed. A material of the insulation layer 132, for example, is a dielectric material, such as polyimide (PI), silicon oxide (SiO), silicon nitride (SiN), silicon oxynitride (SiON), resin, or the like.

It should be mentioned that the touch-sensing display panel 100 in the embodiment depicted in FIG. 2 exemplarily includes two polarizers 128 and 130, which is however not limited in the invention. In another embodiment, the touch-sensing display panel 100 can includes only one of the two polarizers 128 and 130. Namely, the polarizer 128 (disposed on a back surface of the touch-sensing display panel 100) and the polarizer 130 (disposed on a display surface of the touch-sensing display panel 100) can be both disposed on the back surface or the display surface of the touch-sensing display panel 100, such that the images can be characterized by favorable optical effects and high resolution.

According to the embodiments provided above, the color filter films 108, the first electrode layer 110, and the second electrode layer 112 are integrated in the same substrate, and the first electrode layer 110 and the second electrode layer 112 are located on the inner surface 106b and the outer surface 106a of the substrate 106, respectively. Thereby, the touch-sensing color filter substrate 104 can be equipped with both the touch-sensing function and the filter function. Moreover, it is not necessary to assemble additional substrates because the first and the second electrode layers 110 and 112 for performing the touch-sensing function and the color filter films 108 for performing the filter function are integrated on two opposite surfaces of the substrate 106. As a result, the thickness of the touch-sensing display panel 100 can be significantly reduced.

In light of the foregoing, the touch-sensing display panel and the touch-sensing color filter substrate of the invention at least have following advantages. The first electrode layer and the second electrode layer are respectively formed on the inner surface and the outer surface of the substrate in the touch-sensing color filter substrate of the invention, such that the touch-sensing color filter substrate of the invention can be equipped with both the touch-sensing function and the filter function. Therefore, the touch-sensing display panel can be formed by assembling the touch-sensing color filter substrate and the active device array substrate and filling the space between the touch-sensing color filter substrate and the active device array substrate with the display medium. Note that the touch-sensing color filter substrate of the invention has one single substrate that is capable of performing both the touch-sensing function and the filter function, while the conventional color filter substrate is required to be attached to the touch-sensing substrate for performing the two different functions according to the related art. As such, the touch-sensing LCD panel can have reduced thickness.

On the other hand, the touch-sensing display panel of the invention is applicable to any display panel in which the color filter films are needed. That is to say, the touch-sensing display panel of the invention can be applied to various FPDs that display image frames by means of different display media, such that the FPDs can perform the touch-sensing function and display colorful images. Further, two substrates having different functions are integrated into one substrate in the touch-sensing display panel and the touch-sensing color filter substrate of the invention, and thereby the manufacturing processes of the touch-sensing display panel and the touch-sensing color filter substrate can be simplified. Manufacturing costs can be lowered down as well.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A touch-sensing display panel comprising:
an array substrate;
a touch-sensing color filter substrate disposed above the array substrate and comprising:
a substrate having an outer surface and an inner surface opposite to the outer surface;
a plurality of color filter films disposed on the inner surface;
a first electrode layer disposed between the substrate and the color filter films; and
a second electrode layer disposed on the outer surface; and
a display medium arranged between the array substrate and the touch-sensing color filter substrate.

2. The touch-sensing display panel as claimed in claim 1, wherein the first electrode layer comprises a plurality of first touch-sensing series extending along a first direction and arranged in parallel, the second electrode layer comprises a plurality of second touch-sensing series extending along a second direction and arranged in parallel, the first direction and the second direction are not parallel, and the first touch-sensing series are electrically insulated from the second touch-sensing series.

3. The touch-sensing display panel as claimed in claim 1, wherein the touch-sensing color filter substrate further comprises an insulation layer disposed between the first electrode layer and the color filter films.

4. The touch-sensing display panel as claimed in claim 1, wherein the touch-sensing color filter substrate further comprises a light-shielding pattern defining a plurality of sub-pixel regions on the substrate, and each of the color filter films is arranged corresponding to one of the sub-pixel regions, respectively.

5. The touch-sensing display panel as claimed in claim 1, wherein the touch-sensing color filter substrate further comprises a planarization layer covering the color filter films.

6. The touch-sensing display panel as claimed in claim 1, wherein the array substrate comprises an active device array structure, the touch-sensing color filter substrate further comprises a common electrode, and the display medium is disposed between the active device array structure and the common electrode.

7. The touch-sensing display panel as claimed in claim 1, wherein the array substrate comprises a plurality of first stripe electrodes arranged in parallel, the touch-sensing color filter substrate further comprises a plurality of second stripe electrodes arranged in parallel, an extension direction of the first stripe electrodes intersects an extension direction of the second stripe electrodes, and the display medium is disposed between the first stripe electrodes and the second stripe electrodes.

8. The touch-sensing display panel as claimed in claim 1 further comprising a polarizer, the array substrate being located between the polarizer and the display medium.

9. The touch-sensing display panel as claimed in claim 1 further comprising a polarizer, the touch-sensing color filter substrate being located between the polarizer and the display medium.

10. The touch-sensing display panel as claimed in claim 1 further comprising a first polarizer and a second polarizer, the array substrate being located between the first polarizer and the display medium, the touch-sensing color filter substrate being located between the second polarizer and the display medium.

11. The touch-sensing display panel as claimed in claim 1, wherein a material of the first electrode layer and the second electrode layer comprises a transparent conductive material.

12. The touch-sensing display panel as claimed in claim 1, wherein the display medium comprises a liquid crystal material, a discharge gas for generating plasma, an organic luminescent material, or an electrowetting material.

13. A touch-sensing color filter substrate comprising:
a substrate having an outer surface and an inner surface opposite to the outer surface;
a plurality of color filter films disposed on the inner surface;
a first electrode layer disposed between the substrate and the color filter films; and
a second electrode layer disposed on the outer surface.

14. The touch-sensing color filter substrate as claimed in claim 13, wherein the first electrode layer comprises a plurality of first touch-sensing series extending along a first direction and arranged in parallel, the second electrode layer comprises a plurality of second touch-sensing series extending along a second direction and arranged in parallel, the first direction and the second direction are not parallel, and the first touch-sensing series are electrically insulated from the second touch-sensing series.

15. The touch-sensing color filter substrate as claimed in claim 13 further comprising an insulation layer disposed between the first electrode layer and the color filter films.

16. The touch-sensing color filter substrate as claimed in claim 13 further comprising a light-shielding pattern defining a plurality of sub-pixel regions on the substrate, and each of the color filter films is arranged corresponding to one of the sub-pixel regions, respectively.

17. The touch-sensing color filter substrate as claimed in claim 13 further comprising:
a planarization layer covering the color filter films; and
a common electrode disposed on the planarization layer.

18. The touch-sensing color filter substrate as claimed in claim 13 further comprising:
a planarization layer covering the color filter films; and
a plurality of stripe electrodes disposed on the planarization layer.

19. The touch-sensing color filter substrate as claimed in claim 13, wherein a material of the first electrode layer and the second electrode layer comprises a transparent conductive material.
